(19) United States
(12) Patent Application Publication
(10) Pub. No.: US 2025/0321946 A1
(43) Pub. Date: Oct. 16, 2025

(54) System and Method for Data Record Organization, Searching, and Retrieval

(71) Applicant: Fermat International, Inc., Seattle, WA (US)

(72) Inventor: John Harper, Nice (FR)

(21) Appl. No.: 18/637,001

(22) Filed: Apr. 16, 2024

(51) Int. Cl. G06F 16/22; G06F 16/23

(52) U.S. Cl. CPC G06F 16/2282; G06F 16/235

(57) ABSTRACT

Systems and methods are disclosed which facilitate data record organization, searching, and retrieval in connection with large datasets. Data records in large datasets may be organized such that, when a system executes a search of the dataset, each block read responsive to the search contains as many relevant records as possible, minimizing or eliminating cycles spent reading blocks that contain no records that are relevant to the search.

### CROSS-REFERENCE TO RELATED APPLICATIONS

Not applicable.

### FIELD OF THE DISCLOSURE

Aspects of the disclosed subject matter relate generally to high performance data processing, and more particularly to a system and method facilitating data record organization, searching, and retrieval in connection with large datasets.

### BACKGROUND

Recently, “Big Data,” high performance computing, and solid state device technologies have become increasingly important in many contexts, such as in connection with machine learning (“ML”) and artificial intelligence (“AI”) projects, for instance. With the explosion of data available to such systems (as a result, for example, of the nascent Internet of Things (“IoT”), distributed memory systems, and other processing paradigms involving devices sharing data with other devices), the sheer volume of available data to process is increasing faster than traditional hardware and software systems are able to evolve in order to process those data in a meaningful and efficient manner.

Further, most conventional systems designed for high throughput data processing and analytics rely upon exhaustive (or “brute force”) approaches that attempt to overpower the magnitude of the challenge with overwhelming computational resources, at the expense of cycle time and power consumption. As a practical matter, it will be appreciated that for as long as the rate at which new data become available for processing continues to outpace the rate at which processing methodologies advance to accommodate the increased size of a given dataset, it will continue to take longer to solve bigger and more complex data processing problems—or solutions providers will continue to throw more resources at those problems.

Therefore, there is a need for an improved system and method employing a dataset organization strategy that is optimized for resource-intensive search and retrieval applications; as set forth below, some implementations of such a strategy may be configured and operative to leverage known tags associated with data records and to organize those data records at least partially in accordance with the tags (as set forth in detail below, a “tag” in this context may be embodied in or comprise a keyword, string, code, other identifier embedded in or associated with a data record). In accordance with the subject matter disclosed herein, a system employed to search a large dataset may focus processing resources on blocks of data containing the most relevant records and minimize cycles that are devoted to searching through blocks that contain no (or very few) relevant records.

### SUMMARY OF THE DISCLOSURE

The following presents a simplified summary of the disclosure in order to provide a basic understanding of some aspects of various embodiments disclosed herein. This summary is not an extensive overview of the disclosure. It is intended neither to identify key or critical elements of the disclosed embodiments nor to delineate the scope of those embodiments. Its sole purpose is to present some concepts of the disclosed subject matter in a simplified form as a prelude to the more detailed description that is presented later.

The present disclosure describes a system and method facilitating organization, searching, and retrieval of data records from a large dataset; in the context of this description, a “large” dataset is generally meant to encompass any data store, the total contents of which are too great to be accommodated at any given moment in time by the dynamic memory capacity of the system that is tasked with processing it, though other terms may be used by those of skill in the art. In some implementations, data records having similar or identical tags or tag sets may be stored or otherwise maintained in close proximity to each other (e.g., in the same physical or logical block of memory storage, or in contiguous or adjacent blocks) in a bulk memory store, such that subsequent retrieval from the bulk memory store and writing to dynamic system memory need only address a minimal number of blocks. Using the system and methodologies set forth below, each search of the dataset may be focused on retrieval of blocks from the bulk memory store that are rich with records relevant to the search, while blocks having no relevant records may be ignored entirely, or only cursorily reviewed.

In accordance with one aspect of the disclosed subject matter, a method of organizing records in a dataset may generally comprise: identifying a plurality of tags to be used in a search of a dataset, the dataset organized as a list of a number, n, of records from R[1] to R[n]; providing a status identifier for every record in the list and optionally setting the status identifier to an initial value; for every tag in the plurality of tags: initializing an horizon value associated with the tag; reviewing each record in the list to determine if it contains the tag; updating the status identifier for each record responsive to the reviewing, and if a particular record contains the tag, relocating that particular record to a current location of the horizon value, incrementing the horizon value by one, and adjusting a record number for every record in the list affected by the relocating; and recording a range in the list that contains records associated with the tag; and creating a tag set list comprising record ranges associated with every tag and combination of tags.

In accordance with another aspect of the disclosed subject matter, a method of retrieving records from a dataset may generally comprise: consulting a tag set list to determine a range of records in the dataset that contain a tag in a query; and accessing an address in a memory store to retrieve a block of data that contain records within the range.

In accordance with yet another aspect of the disclosed subject matter, a system for retrieving records from a dataset may generally comprise hardware and software appropriate for executing the disclosed methods. For example, a system for retrieving records from a dataset may generally comprise: a bulk memory store partitioned into a plurality of addressable blocks and storing the dataset; and a compute component operative in accordance with computer readable instructions, the instructions causing the compute component to: consult a tag set list to determine a range of records in the dataset that contain a tag in a query; and access an address in the bulk memory store to retrieve a block of data that contains records within the range.

The foregoing and other aspects of various disclosed embodiments will be apparent through examination of the following detailed description thereof in conjunction with the accompanying drawing figures, in which like reference numerals are used to represent like components throughout, unless otherwise noted.

### DESCRIPTION OF THE DRAWING FIGURES

FIG. 1 is a simplified diagram illustrating one implementation of a dataset structure and depicting notational references used in the drawing figures which follow;

FIG. 2 is a simplified diagram illustrating the dataset structure of FIG. 1 in an initial or default state, in which a respective status of each respective record is unknown;

FIG. 3 is a simplified diagram illustrating the dataset structure of FIG. 2 in a first state in which a first tag is considered, and in which a respective status of each respective record is known as to the first tag;

FIG. 4 is a simplified diagram illustrating the dataset structure of FIG. 3 in a second state in which a second tag is considered, and in which a respective status of each respective record is known as to the second tag; and

FIG. 5 is a flow diagram illustrating aspects of one implementation of a method of organizing records in a dataset.

### DETAILED DESCRIPTION

Certain aspects and features of the disclosed subject matter may be further understood with reference to the following description and the appended drawing figures. In operation, a system and method of organizing, searching, and retrieving data records from large datasets may have utility in connection with various data processing strategies and data analytics implementations. Specifically, the present disclosure contemplates a storage, retrieval, and data processing platform that may generally comprise hardware and software, all operating with respect to data records maintained in a bulk memory store, but the present disclosure is not intended to be limited by the nature, construction, or operational characteristics of the hardware and software employed for such data processing operations. The following background is provided by way of example only, and not by way of limitation.

It will be appreciated by those of skill in the art that the systems and methods disclosed herein may employ or be executed by a computer device or data processing apparatus as generally known in the art. For example, such a device may be embodied in or comprise a computer server, a desktop or workstation computer, a laptop or portable computer or tablet, or a combination of one or more of such components. In operation, a device or constituent compute component (described below) associated therewith may be employed to initiate, instantiate, or otherwise to effectuate data processing operations. In that regard, a device may include one or more microprocessors, field programmable gate arrays (“FPGAs”), microcontrollers, or other digital processing apparatus, along with attendant memory, controllers and firmware, communications busses, network interface hardware, and the like. For example, such a device may generally comprise multiprocessor systems, microprocessor-based or programmable consumer electronics, personal computers (“PCs”), networked PCs, minicomputers, mainframe computers, and similar or comparable apparatus for general purpose or application-specific data processing. Various implementations of devices may be deployed in distributed computing environments in accordance with which tasks or program modules may be performed or executed by remote processing devices, which may be linked through a communications network. Those of skill in the art will appreciate that any of various computer servers, work stations, or other processing hardware components or systems of components may be suitable for such arrangements and processing tasks, and that the disclosed subject matter is not limited to any particular hardware implementation or system architecture.

It is also noted that, with respect to requesting, initiating, enabling, facilitating, and receiving results of any data processing operations, such as data record searches and retrievals, the device executing the search may be communicatively coupled to routers, bridges, communications channels, or other networked devices, such as via a bus or communications hardware such as an input/output (“I/O”) interface. In operation, an I/O interface generally enables bi-directional data transmission in accordance with any of various communications interfaces or telecommunications protocols generally known in the art or developed and operative in accordance with known principles, and generally supports the use of such devices in communication with other devices in a distributing processing architecture as well as in connection with accessing data records in a bulk memory store (whether local or remote).

A system employing the disclosed methods may generally comprise such a device as described above, having one or more microprocessors, FPGAs, application specific integrated circuits (“ASICs”), programmable logic blocks, microcontrollers, or other digital processing apparatus (a “compute component”) suitable for data processing in accordance with requirements or design specifications of the device in which it is used. Typically, a compute component in the device cooperates with or operates in connection with a local dynamic memory, which may generally comprise or have access to, by way of example, volatile memory such as random access memory (“RAM”) in any of its various forms, for instance, static RAM (“SRAM”), dynamic RAM (“DRAM”), double-data rate (“DDR”) RAM, and the like; in some applications, DDR4 RAM may be used as or in connection with this dynamic memory. Additionally or alternatively, the compute component generally has access to a mass data storage component, such as a non-volatile data storage device, such as disk drives, optical drives, other spinning media data stores, or solid state drives, one example of which is an Electronically Erasable Programmable Read Only Memory (“EEPROM”) store (individually or collectively, a “bulk memory store”). For example, a bulk memory store may be, or include, Flash memory, though other memory types having suitable or appropriate characteristics to facilitate the functionality of a device for searching and retrieving records from datasets may be in use currently or developed in the future. Specifically, any of various types of processing hardware and firmware, as well as volatile and non-volatile storage media, may have utility in the context of operation of a system as set forth herein (which may be application- or system-specific), and the present disclosure is not intended to be limited by the nature or operational characteristics of its memory (dynamic or bulk) or its compute component.

By way of further background, it is noted that there are many applications, including but not limited to artificial intelligence (or “AI”), in which extremely large databases or other structured or unstructured datasets are to be searched for “relevant” records, i.e., those records in the dataset that most closely match specified criteria (sometimes referred to as a “query”). In many such applications, both the query and the data records are represented by vectors, which may have utility in speeding the search (sometimes at a cost of slightly reduced thoroughness), as is generally known in the art. Typically, relevant records that are identified responsive to a search consist of those having relatively short vector distances from the query's vector, generally consistent with a requirement that, to be considered relevant, a record's vector should or must match or include one or more identifying “tags” specified by the query vector. In this context, the term “tag” may be broad enough to include keywords, strings, codes, specific data values, specific null or nonce identifiers, metadata, hashes, or other indicia embedded in or associated with a data record. Many such tags may be employed in connection with a particular dataset or query, and the disclosed subject matter is not intended to be limited by the nature, dimensions, number of significant bits or bytes, or other characteristics of the tags used for organizing, searching, or retrieving data records.

In any event, when the dataset is too large to fit in dynamic memory of the device conducting a search, it must be retrieved from a bulk memory store such as a hard disk or solid state memory device. Such devices do not permit individual records to be accessed; rather, access to such a bulk memory store is by blocks, each of which is typically on the order of several thousand bytes or more in storage capacity. Identifying such data, then reading it from the bulk memory store, and writing it to dynamic memory where it can then be processed, is relatively slow; accordingly, executing these procedures for a large block of memory that contains few relevant records is inefficient. In practice, it is generally more efficient to minimize the number of blocks that must or should be read to identify records that are relevant to a particular query. Specifically, substantial performance gains may be realized if data records maintained in a large dataset are organized such that each block to be read responsive to a query contains as many relevant records as possible, and that time spent reading blocks that contain no or very few relevant records is minimized or eliminated.

For applications involving a small number of identifying tags, this is a well-known problem in database technology that is addressed by an equally well-known solution—the use of indices that keep track of record locations. In typical AI or large language model (“LLM”) databases, however, there may be thousands (or tens of thousands) of tags that may be used for organizational or retrieval (i.e., querying) purposes. It is neither practical nor operationally prudent to build a conventional index for each of these tags.

In a departure from conventional methodologies, however, the present system and method facilitate organizing records in a large dataset in such a way that, to the extent possible, records carrying or otherwise associated with the same tag are organized in the same block (i.e., at closely related logical or physical memory addresses) or in contiguous blocks in the bulk memory store, and that a list of relevant blocks for each tag is known.

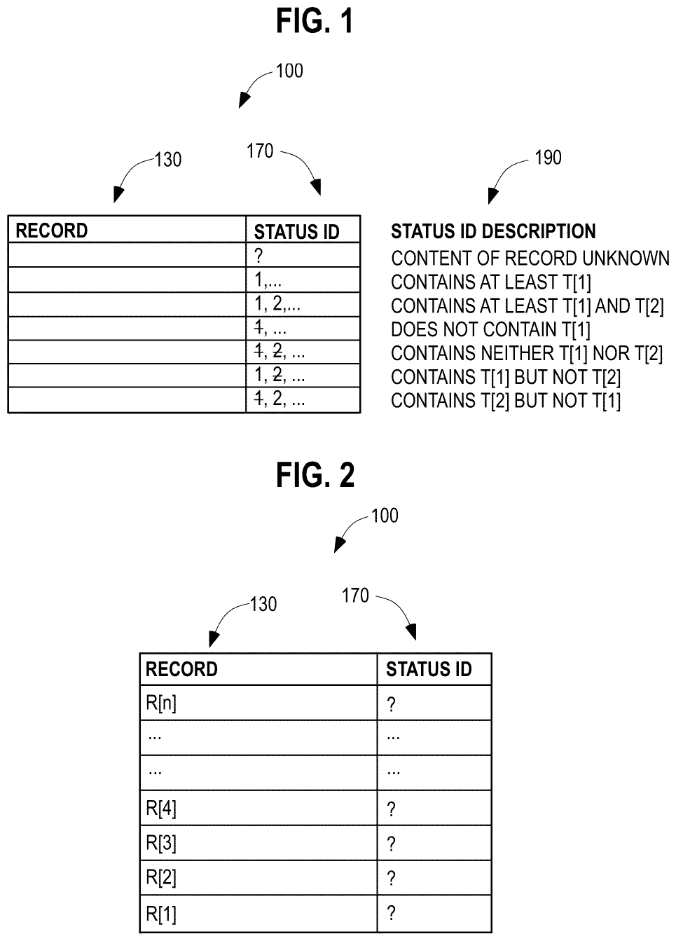

Turning now to the drawing figures, it is noted that FIG. 1 is a simplified diagram illustrating one implementation of a dataset structure and depicting notational references used in the drawing figures which follow. As indicated, dataset 100 may generally comprise a data record field 130 and a status identifier field (depicted as “Status ID” at reference numeral 170). It should be appreciated that the “status ID description” text depicted at the right side of FIG. 1 is provided for reference and by way of example only, and solely to assist with understanding the subject matter set forth herein. Specifically, such status ID descriptions (reference numeral 190 in FIG. 1) are not part of dataset 100, but provide context for interpreting the symbology in the following drawing figures.

In the illustrated example, a question mark (“?”) status ID indicates that the content of a particular record is unknown, such as in the initial state illustrated in FIG. 2. A status ID of “1, . . . ” indicates that a given record contains at least a first tag, T[1], while a status ID of “1, 2, . . . ” indicates that a given record contains at least first tag T[1] and a second tag, T[2]. A status ID of “ [symbol] , . . . ” (the numeral “1” with a strikethrough) indicates that a given record does not contain T[1], while a status ID of “ [symbol] , [symbol] , . . . ” (the numerals “1” and “2,” both with a strikethrough) indicates that a given record contains neither T[1] nor T[2].

With this basic strategy, it is possible to extrapolate this tag identification paradigm out to an arbitrary number of tags. For example, a status ID of “1, [symbol] , . . . ” indicates that a given record contains T[1] but not T[2], while a status ID of “ [symbol] , 2, . . . ” indicates that a given record contains T[2] but not T[1]. The convention of a numeral with a strikethrough may be replace, as desired, by any symbol sufficient to convey or otherwise to connote that a particular tag is not present in a record. With enough symbols, such as (for example) nX or *Y to indicate “not tag T[X]” or “not tag T[Y],” respectively, any number of tags may be accommodated with a given convention. The status ID indicators illustrated in the drawing figures are provided only by way of example, and not by way of limitation.

Those of skill in the art will appreciate that column 130 representing data records in the drawing figures is abstracted, and that a data record itself may be a large and complicated set of data fields, such as in a database, for instance. Specifically, a “record” in this context may be embodied in or comprise any number of fields or subfields of data, which may be expressed in characters, numerals, codes, hash functions, and the like, and may be vectorized to facilitate searching as is generally known in the art. For example, a record recorded at a row specified in column 130 may be embodied in or comprise the entirety of (or only portions of) computer source or object code, articles, white papers, novels, integers or strings, mathematical expressions or functions, images or image data with embedded metadata, or any other data as may be maintained in a structured or unstructured database. The present disclosure is not intended to be limited by the size or character of the data records maintained in dataset 100 (i.e., as represented in record column 130).

In an ideal case, it is preferable that all the records that match a given tag are organized to be adjacent and sequential in storage (such as a bulk memory store), such that a read operation in connection with the given tag will read only those records that match that specific tag (with the possible exception of some additional records at the beginning and the end of the block that are outside the range of the relevant records). If every record matched exactly one tag, this ideal scenario would be possible to implement in a simple storage strategy; records would be arranged in respective groups, with each respective group associated with a respective tag contained in every constituent record in the group.

In practice, however, a single record may match several or many tags. In one corpus of data (for example, a publicly available dataset used for benchmarking purposes), the average number of tags per record may be between about ten and eleven, with some records having much larger numbers, including several records with over one thousand matching tags. Considering just the case of records matching one, two, or three tags, even a cursory inspection will lead to the conclusion that it is not possible to achieve perfect grouping for all three of the tags (without duplicating data records, which is undesirable for a number of reasons). Similarly, it is often the case, even in simple datasets and small numbers of tags, that a single tag will typically be associated with many records. In the same corpus of data mentioned above, for example, the average number of records associated with a tag is about five-hundred forty, with several tags exceeding one million associated records.

As set forth in more detail below, the method described herein groups records to the extent reasonably possible given processing constraints, taking into account the above-described impossibility of achieving perfection, organizing them in such a manner as to minimize processing cycles that are devoted to searching for records that are known not to contain a tag contained in a given query.

Initially, the records are stored in no particular order (with respect to the tags that they match or contain) in a sequential list of records referred to as R. In this context, the notation R[n] is intended to mean the current nth record in the list R, where R[1] is the first such record in the list. FIG. 2 is a simplified diagram illustrating the dataset structure of FIG. 1 in an initial or default state, in which a respective status of each respective record is unknown. This is the starting point of any arbitrary dataset, prior to its being evaluated and organized as set forth below. Every record (i.e., R[1] through R[n] at column 130 on the left of FIG. 2) is provided a status ID of “?” (at column 170 on the right of FIG. 2) indicating that its contents (with respect to a specific set of tags T[1] through T[Y], where “Y” represents an arbitrary number of tags and T[Y] represents the Y^{th} tag) are currently unknown.

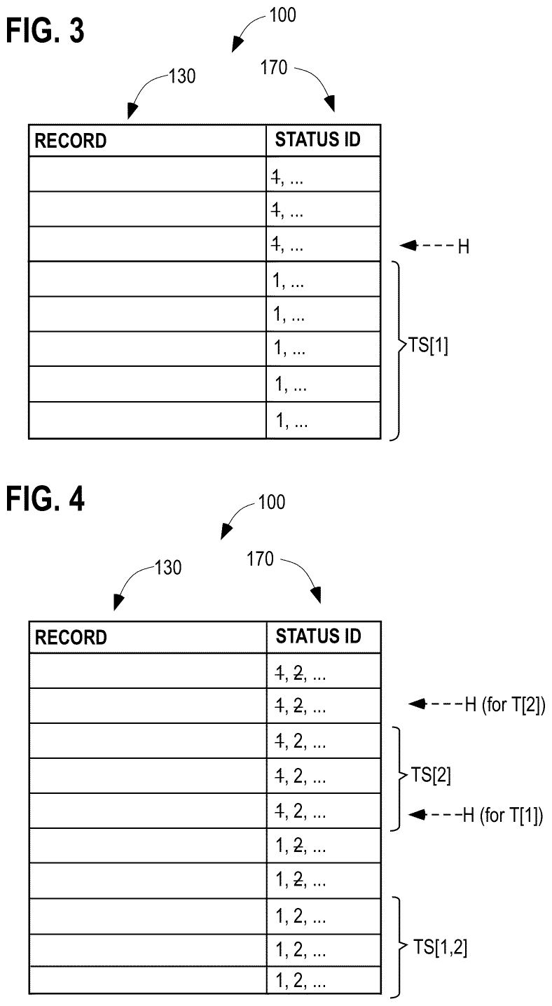

FIG. 3 is a simplified diagram illustrating the dataset structure of FIG. 2 in a first state in which a first tag is considered, and in which a respective status of each respective record is known as to the first tag. At this point, a first tag (say, tag T[1]) is selected for the purpose of arranging its matching records in the list R (column 130). While this first tag is referred to as T[1], it is noted that the disclosed method will be effective irrespective of which tag (T[1] through T[Y]) is selected at this initial stage. In some circumstances, it may be appropriate or desirable to select the one tag that matches the largest number of records, if that tag were known, for the first organizational pass through the data records R[1] to R[n]. A variable called the “horizon” (referred to as H) and indicated in FIG. 3 may be employed to indicate the current lowest record in R that is known not to match T[1]. H is initially set to the value 1, and will percolate up the list R as set forth below.

In this first organizational pass through the list of records, each record R[1] to R[n] is examined in sequence, starting with R[1]. If the record does not match T[1], it is left in place and H is not changed. If a particular record does match T[1], then that particular record is swapped with the record at the position indicated by H, and the value of H is incremented by 1. It is noted that records between H and the particular record swapped with H will be renumbered due to the swapping operation; specifically, when a record is moved to the position occupied by H and H is incremented by 1, then records higher in the list than H but lower than the location from which the swapped record previously occupied must be reordered. Once all records in the list R have been reviewed, and possibly reordered, in this manner, all records in the range R[1] to R[H−1], whatever the value of H, are now known to match T[1].

At this point, the dataset 100 structure has the state illustrated in FIG. 3. All records that match T[1] are grouped together in the range R[1] to R[H−1] (indicated by the status ID “1, . . . ” in column 170), and all of the remaining records, from R[H] to the end of the list (i.e., R[n]), are known not to match T[1] (indicated by the status ID “ [symbol] , . . . ” in column 170; this may be indicated by “*1,” “#1,” “x1,” or “n1,” as alternatives, or by any other symbol indicative of an absence of T[1] in a particular record). Hence for T[1], at least, the ideal scenario has been achieved, and all matching records are grouped together. If, during subsequent retrieval operations, it is required to access all records matching T[1], it is necessary to inspect only records in this range, R[1] to R[H−1]. This will remain true even after grouping has been performed for all tags in a given set of tags T[1] through T[Y], because while subsequent operations (as described below) may reorder these records within this range, such operations will not modify the scope of this range by adding or removing any records.

It will be appreciated at this point that it may be desirable to record or maintain a list so as to memorialize the range of records in the dataset that include a respective tag. In one implementation, such a list may be referred to as a tag set list, or “TS,” and may be employed to record all ranges associated with every tag (from T[1] through T[Y]) or combinations of such tags. At the point illustrated in FIG. 3, by way of example, only a single tag (T[1]) has been reviewed, and so only a single entry is created for tag T[1] in TS (say, TS[1], for instance). In this example, TS[1] would record or otherwise indicate the range R[1] to R[H−1] as the range of data records associated with or matching T[1]. At every iteration through the organization and reordering process, a new value for TS may be added for the respective tag reviewed during the iteration.

FIG. 4 is a simplified diagram illustrating the dataset structure of FIG. 3 in a second state in which a second tag is considered, and in which a respective status of each respective record is known as to the second tag. A similar operation to that described above may now be performed for a second tag, T[2]. This operation may take into account that the records have already been separated into two ranges, those that match T[1] (i.e., TS[1]) and those that do not. First, the records in TS[1] may be scanned, parsed, or otherwise examined in order, once again grouping those that also match T[2] first, followed by those that do not. An entry may be added to TS (for example, an entry labeled or entitled “TS[1,2]”) that represents the records that match both T[1] and T[2]. Then, the remaining records may be examined for T[2] alone, grouping those that match T[2] (but not T[1]) first, followed by those matching neither T[1] nor T[2]. The former group may represent a group of records added to TS (e.g., as “TS[2]”). It is to be noted that while the order of the records in TS[1] may have been changed as a consequence of some also matching T[2] while others do not, no record has been added or removed from the range R[1] through R[H−1] in FIG. 3, and so the original range recorded in TS[1] need not be adjusted. Specifically, after the reordering represented in FIG. 4, TS[1] still represents all records that match T[1], regardless of what other tags they may also match. Searches for T[2] need only to examine the ranges TS[1,2] and TS[2], and may ignore ranges of records other than those, as records in those other ranges have been determined not to contain or to match T[2].

As noted above, FIG. 4 illustrates the state of dataset 100 after this reordering for T[2]. Records matching T[1] and T[2] are shown with the status ID “1, 2, . . . ” in column 170; records matching T[1] but not T[2] are shown with the status ID “1, [symbol] , . . . ” in column 170; records matching T[2] but not T[1] are shown with the status ID “ [symbol] , 2, . . . ” in column 170; and records matching neither T[1] nor T[2] are shown with the status ID “ [symbol] , [symbol] , . . . ” in column 170. As noted above, the “not T[#]” state could easily be indicated by “n #, . . . ” or “*#, . . . ” or something similar, and the depicted convention is illustrated by way of example only.

It will be appreciated that a third tag, and subsequent tags, may be reviewed and added in a similar manner as described above, with each successive organizational pass through the list R of records reordering the records in accordance with the tags with which they are associated, but not affecting the total ranges of data records established by previous iterations. As for subsequent operations after the state illustrated in FIG. 4, each of the existing ranges TS[1,2], TS[1], and TS[2] may be examined and reordered as appropriate, but the scope of each range will not change. Once the next successive iteration (e.g., for a third tag, T[3]) is complete, the following tag sets exist, in this order: TS[1,2,3], TS[1,2], TS[1,3], TS[1], TS[2,3], TS[2], TS[3]. Some of these may be empty—for example, if there are no records that match only T[2] and T[3], then T[2,3] will be empty. In some implementations, empty ranges may not be recorded to economize on memory storage required for the tag set list, TS.

In the foregoing manner, following every tag having been processed, the tag set list, TS, of non-empty tag sets will contain an entry for every combination of tags which has been found to exist during the organization operation. The final size of the tag set list, TS, will be less than the total number of records, since every entry in TS must contain at least one record, and may likely contain many more than one.

The process of retrieving records from dataset 100 that match a particular tag may be effectuated substantially as follows. In the description below, the tag sought to be located in dataset 100 is denoted as “T[s].” A system or its constituent compute component may, under software control, for example, examine every entry in TS, searching for ranges in R having those records which contain the value “s.” Each such group of records known to contain “s” (as determined by an examination of TS) may then be retrieved and subjected to whatever other filtering operations apply, which may be application-specific. For example, in a vector database used for AI or LLM processing, records may be ranked according to their Euclidean vector distance from the sought vector (i.e., a vectorized representation of the query), with only a small number having the shortest distance (or range of distances) being retained. The number of records thus retrieved for any given search of dataset 100 will generally be substantially smaller than the total number of records, with a corresponding decrease in the amount of data that must be transferred from a bulk memory store; accordingly, the time required to execute a given retrieval operation may be minimized or otherwise appreciably reduced when a system or method conducting the retrieval begins the search using TS and consulting blocks that are already known to contain “s,” rather than parsing every record in dataset 100.

In one example following the above-described paradigm, a method of retrieving records from a dataset may generally comprise consulting the tag set list TS to determine a range of records in the dataset that contain a tag (such as T[s]) in a query, and then accessing an address in a memory store to retrieve a block of data that contains records within the range. Where the search is limited to those addresses (and only those addresses) in the memory store, then wasted cycles may be eliminated or minimized.

In practice, many sophisticated retrieval operations will specify more than one tag. In that case, the tag that matches the smallest number of records (again, as determined by an examination of TS and the data record ranges associated with each identified tag) may be used to select which records are read, thereby ensuring that the smallest amount of data may be transferred from a bulk memory store into dynamic memory for processing. For example, suppose that a query requires identification of records matching tags T[11], T[222], and T[3333], and that each respective one of these tags is matched with, respectively, ten thousand records, five hundred records, and three thousand records. In such a situation, it may be useful to use tag T[222] (to retrieve just 500 records) rather than the other tags, which would require retrieval of up to twenty times as many records. As the records are processed, further filtering may be applied to exclude those records that do not also match other required tags (such as tags T[11] and T[3333] in the foregoing example).

It will be appreciated that, rather than scanning the entire list of tag sets in TS, an implementation may contain explicit representation of the tag sets associated with each tag.

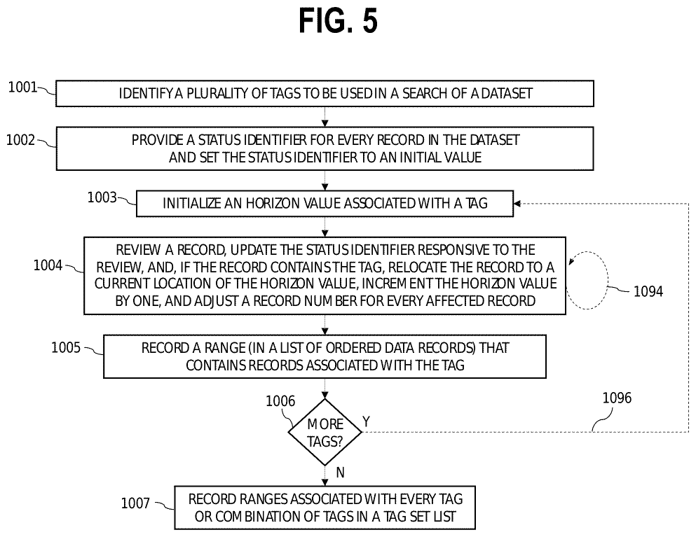

FIG. 5 is a flow diagram illustrating aspects of one implementation of a method of organizing records in a dataset. As indicated at block 1001, such a method, for any given dataset such as dataset 100 described above), may begin by identifying a plurality of tags to be used in a search of the dataset. As set forth in detail above in connection with FIGS. 1 and 2, the dataset may be organized as a list of a number, n, of records from R[1] to R[n]; this may be true irrespective of the physical orientation or location of any particular record. In practice, the order of the records is more important than the arrangement. For instance, low numbers may be at the bottom of a list presented in tablature form and increasing from bottom to top (such as in FIG. 2), or low numbers may be at the top of such a list (as in the numbered rows of a spreadsheet, for instance) and increase from top to bottom. Similarly, records may be oriented vertically, with numbered positions incrementing from left to right, or vice-versa. The manner in which the records are ordered originally is immaterial, and may be a function of the original structure of the data store device maintaining the dataset, the manner in which that data store device is partitioned, or a combination of these and a variety of other factors.

Also as noted above, the tags (as contemplated in the operation depicted at block 1001) may be keywords, characters, strings, numerals or numeric values, variables, metadata, etc. sought to be located in records maintained in the dataset. Tags may be simple or complex, as is generally known in the art, and the present disclosure is not intended to be limited by any particular nature, size, or character of the tags employed for organizing (or subsequently searching and retrieving) records in a dataset.

The method may continue by providing a status identifier for every record R[1] to R[n] in the list and (optionally) setting the status identifier to an initial value as indicated at block 1002. In some instances, a flag or other indicator may be used to inform a system organizing the dataset that, upon a first iteration, a status value for each record is to be ignored (and thus, it may not be necessary to “set” or “initialize” a status value, ab initio, for a record-it may just be assumed or ignored in some implementations). The initial value for each status identifier is not as important as the fact that the system recognizes a field or a dedicated number of bits or bytes to be utilized to provide a status identifier associated with each record (substantially as set forth above in connection with FIGS. 3 and 4) as the organization proceeds.

For a respective tag selected from a plurality of tags used for the organization of the dataset, the method may continue by initializing an horizon value associated with the respective tag. As noted above, for the first tag in a sequence, this horizon value may be initialized at “1,” which will ensure that the records matching the first tag will be maintained in a range of records in the dataset starting at “1” (i.e., the “first” record in the dataset), and continuing to record R[H−1] as described in detail above. For subsequent iterations during the organization of the dataset examining records with a different tag, the horizon will be initialized differently, depending upon the range of records occupied by records matching tags that were previously examined (see, e.g., the discussion of FIG. 4 above).

For a tag having an horizon value so initialized, the method may continue by reviewing each record in the list (i.e., the entire dataset), updating the status identifier for each record responsive to the reviewing (i.e., providing an indication of whether the tag is contained in the record), and, if a particular record contains the respective tag, relocating that particular record to a current location of the horizon value, incrementing the horizon value by one, and adjusting a record number for every record in the list affected by the relocating (i.e., every record higher in the list than the current horizon value but lower in the list than the relocated record will have a new place in the list, since the relocated record will be slotted into the list below). These operations are depicted at block 1004 (and described above in connection with FIGS. 3 and 4). The dashed arrow (reference numeral 1094) illustrates the iterative nature of these operations, as they are carried out on every record in the list.

When all the records have been reviewed, and their status and location in the list has been reordered as set forth above, the method may continue by recording a range of the list that contains records associated with the respective tag, as indicated at block 1005. This range (e.g., R[1] through R[H−1] for tag T[1]) represents the locations in the list at which the records associated with the specific tag reside. In the foregoing manner, all records matching, containing, or otherwise associated with particular tag are organized contiguously in the list, such that they will most likely be written in the same block (or at least contiguous blocks) in a bulk memory store for efficient retrieval at a later time.

A determination may be made whether the data records are to be reviewed in connection with more tags, as indicated at the decision block 1006. If more of the plurality of tags remain to be used for organizing the dataset records (“Y” out of decision block 1006), then the method may continue by repeating the initializing an horizon value, reviewing the records, updating each record status identifier, relocating matching records, incrementing the horizon value, adjusting a record number for all affected records, and recording the range of records associated with the addition tag. This is represented by the dashed loop (reference numeral 1096) back to block 1003; accordingly, the forgoing procedures may be iterated for every respective tag in the plurality of tags. If there are no further tags to be used for organizational purposes (“N” out of decision block 1006), then the method may continue by recording all ranges associated with every tag or combination of tags in a tag set list (such as TS described above) as indicated at block 1007.

In summary, a method of organizing records in a dataset may make use of tags that are known to be of interest in connection with subsequent searches, and uses those tags to arrange the records within the dataset such that those records with identical or similar tags or tag combinations are clustered together for efficient storage and subsequent retrieval. In connection with a search, a search algorithm may address a tag set list (such as TS described above) to identify ranges of records within the dataset that contain tags or tag sets that match (or most closely approximate) tags in a particular search query; accordingly, every record in the dataset need not be read from a bulk memory store (a slow process) and written to dynamic memory only to be identified as irrelevant to the query-only blocks of the bulk memory store known to contain relevant records need be retrieved.

It is noted that the arrangement of the blocks and the order of operations depicted in FIG. 5 are not intended to exclude other alternatives or options. For example, it will be appreciated that in accordance with one implementation, the operations depicted at blocks 1001 and 1002 may be reversed in order, executed substantially simultaneously, or even integrated into a single operation. As another example, the various operations depicted at block 1004 may be executed independent of each other, or the adjusting a record number operation may be executed concomitantly with the operation at block 1005, where the recorded range is adjusted as the record numbers are updated (rather than after-the-fact). Further, those of skill in the art will appreciate that the operations depicted at blocks 1005 and 1007 may occur substantially simultaneously, such that the tag set list is dynamically updated as the range information for each tag is determined.

Further, it is noted that the term “increment” is used in block 1004 only to be consistent with the foregoing description of an example dataset 100 (see FIG. 2, which illustrates R[1] at the bottom and R[n] at the top). As noted above, however, the order of dataset 100 may be different than that depicted in the drawing figures. In the case where the list R of records is reversed, and record numbers increase from top to bottom (as is the case in many spreadsheet conventions, for instance), the horizon value may be “decremented” rather than incremented when a matching record is relocated.

The foregoing and other alternatives may readily be effectuated without materially impacting results of the method or the functionality of any particular hardware implementation utilized to execute the method. In addition to the alternatives set forth in detail above, various design choices that may influence the order or arrangement of the operations depicted in FIG. 5 will be readily apparent to those of skill in the art.

Several features and aspects of a system and method have been illustrated and described in detail with reference to particular embodiments by way of example only, and not by way of limitation. Those of skill in the art will appreciate that alternative implementations and various modifications to the disclosed subject matter are within the scope and contemplation of the present disclosure. Therefore, it is intended that the present disclosure be considered as limited only by the scope of the appended claims.

1. A method of organizing records in a dataset, the method comprising:
identifying a plurality of tags to be used in a search of a dataset, the dataset organized as a list of a number, n, of records from R[1] to R[n];
providing a status identifier for every record in the list and optionally setting the status identifier to an initial value;
for every tag in the plurality of tags:
initializing a horizon value associated with the tag;
reviewing each record in the list to determine if it contains the tag;
updating the status identifier for each record responsive to the reviewing, and
if a particular record contains the tag, relocating that particular record to a current location of the horizon value, incrementing the horizon value by one, and adjusting a record number for every record in the list affected by the relocating; and
recording a range in the list that contains records associated with the tag;
and
creating a tag set list comprising record ranges associated with every tag and combination of tags:
whereby the records in the dataset are organized in memory blocks according to the tags, such that a number of memory blocks retrieved responsive to a query is minimized by consulting the tag set list.

2. A method of retrieving records from a dataset, the method comprising:
consulting a tag set list to determine a range of records in the dataset that contain a tag in a query; and
accessing an address in a memory store to retrieve a block of data that contains records within the range;
wherein the records are organized in the memory store according to the tags, such that a number of blocks retrieved responsive to a query is minimized by consulting the tag set list.

3. A system for retrieving records from a dataset, the system comprising:
a bulk memory store partitioned into a plurality of addressable blocks and storing the dataset; and
a compute component configured in accordance with computer readable instructions, the instructions causing the compute component to:
consult a tag set list to determine a range of records in the dataset that contain a tag in a query; and
access an address in the bulk memory store to retrieve a block of data that contains records within the range;
wherein the records are organized in the addressable blocks according to the tags, such that a number of addressable blocks retrieved by the compute component responsive to a query is minimized by consulting the tag set list.
